(19) United States
(12) Patent Application Publication
(10) Pub. No.: US 2026/0214281 A1
(43) Pub. Date: Jul. 23, 2026

(54) INTRA-FRAME PREDICTION IN POINT CLOUD ATTRIBUTE COMPRESSION

(71) Applicant: InterDigital CE Patent Holdings, SAS, Paris (FR)

(72) Inventors: Gustavo Sandri, Cesson-Sevigne (FR); Bertrand Chupeau, Rennes (FR); Franck Thudor, Rennes (FR)

(21) Appl. No.: 19/146,021

(22) PCT Filed: Jan. 3, 2024
(86) PCT No.: PCT/EP2024/050093

§ 371 Date: Jul. 7, 2025

(30) Foreign Application Priority Data
Jan. 6, 2023 (EP) 23305017.8

(51) Int. Cl. H04N 19/96; H04N 19/159; H04N 19/196; H04N 19/593

(52) U.S. Cl. CPC H04N 19/96; H04N 19/159; H04N 19/196; H04N 19/593

(57) ABSTRACT

To encode and decode a point cloud, the point cloud is represented by an octree of nodes comprising a spatial location and a list of attribute values like color, reflectance, normal vectors, etc. An early termination decision workflow to disable the transform domain prediction is disclosed. According to the present principles, the distance to the tree root, that is the level of the node in the octree, is used as a parameter to predict when it is necessary to execute the intra frame prediction and, outlier nodes are removed before computing the prediction. In this embodiment, the memory byte consumption is reduced by four times the number of points.

### CROSS REFERENCE TO RELATED APPLICATIONS

This application claims the benefit of European Application No. 23305017.8, filed on Jan. 6, 2023, which is incorporated herein by reference in its entirety.

### 1. Technical Field

The present principles generally relate to the domain of compression of a point cloud comprising attribute data. The present document is also understood in the context of the encoding, the formatting and the decoding of data representative of a point cloud for example for a rendering of volumetric content on end-user devices such as mobile devices or Head-Mounted Displays (HMD). In particular, the present document relates to the compression of the attributes, like color, reflectance or normal vectors associated with the points of a point cloud.

### 2. Background

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Advances in 3D (three-dimensional) capturing and rendering technologies are enabling new applications and services in the fields of autonomous driving, cultural heritage archival, immersive telepresence and virtual/augmented reality. Point clouds have arisen as one of the main 3D scene representations for such applications. A point cloud frame consists of a set of 3D points, each point being represented by its 3D position and possibly several attributes such as color, transparency, reflectance, normal vector, etc.

The geometry of the point cloud (i.e. the position of the points in the 3D space) may be represented by an octree, that is a tree dividing the space in eight voxels at each level of the tree. A node contains a 1 if the voxel comprises at least one point, and a 0 otherwise. The number of levels of the tree may be adapted to manage the resolution at which one may want to represent the data. Attributes of a voxel is, for example, an average of the attributes of the points contained in this voxel (that is a node of the octree). The size of the data required to encode the attributes is reduced if the values of a node can be predicted from the values of its parents, uncles and or siblings in the octree.

A standardization activity for point cloud compression is carried out by the ISO/IEC JTC1/SC29/WG7 “MPEG 3D Graphics and Haptics Coding” group (GPCC). The region-adaptive hierarchical transform (RAHT) is one of the two transforms for attribute encoding in G-PCC. The RAHT is performed on the occupancy tree (octree) representation of the point cloud, starting from the leaves of the octree (highest level), and proceeding backwards until reaching the root (lowest level). At each node, the transform is performed in three steps—along each x, y and z directions—to generate low-pass and high-pass coefficients. In G-PCC an up-sampled transform domain prediction was introduced to improve RAHT encoding coding efficiency. For each block, the transformed upconverted sum of attributes at current level d, calculated from the decoded sum of attributes at lower level d−1, is used as a prediction to the transformed sum of attributes at level d, generating high-pass residuals that can be further quantized and entropically encoded. The upconverting process is accomplished by means of a weighted average of neighboring nodes.

The RAHT prediction is not always useful. Indeed, when a given node has few neighboring nodes in the previous level, for example, the prediction may be unsatisfactory and only result in an increase of computing time without apparent gain. In such cases, an early termination decision flow of the transform domain prediction is possible. It is also possible to disable the prediction when there is a single occupied child in the current node as no transform will be performed in this case, yielding the early termination decision flow.

The current early termination decision workflow to disable the transform domain prediction of RAHT is complex and tuned by hand. There is a lack for a method that simplifies this process to obtain a lower complexity with no impact on coding performance.

### SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method comprising obtaining a node tree linking nodes representative of a point cloud. For a considered node of the node tree, an attribute value of a considered node is predicted only if a level of the considered node in the node tree is lower than a first threshold and if the number of siblings of the considered node is greater than zero and if the number of valid neighbor nodes of the considered node is lower than a second threshold.

The present principles relate to a device comprising a memory associated with a processor configured for implementing the method above.

### BRIEF DESCRIPTION OF DRAWINGS

The present disclosure will be better understood, and other specific features and advantages will emerge upon reading the following description, the description making reference to the annexed drawings wherein:

FIG. 1 illustrates an early termination decision workflow to disable the transform domain prediction;

FIG. 2 illustrates an early termination decision workflow to disable the transform domain prediction according to the present principles;

FIG. 3 shows an example architecture of a device which may be configured to implement a method for encoding or decoding a point cloud according to the present principles;

FIG. 4 shows an example of an embodiment of the syntax of a stream when the data are transmitted over a packet-based transmission protocol.

### DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

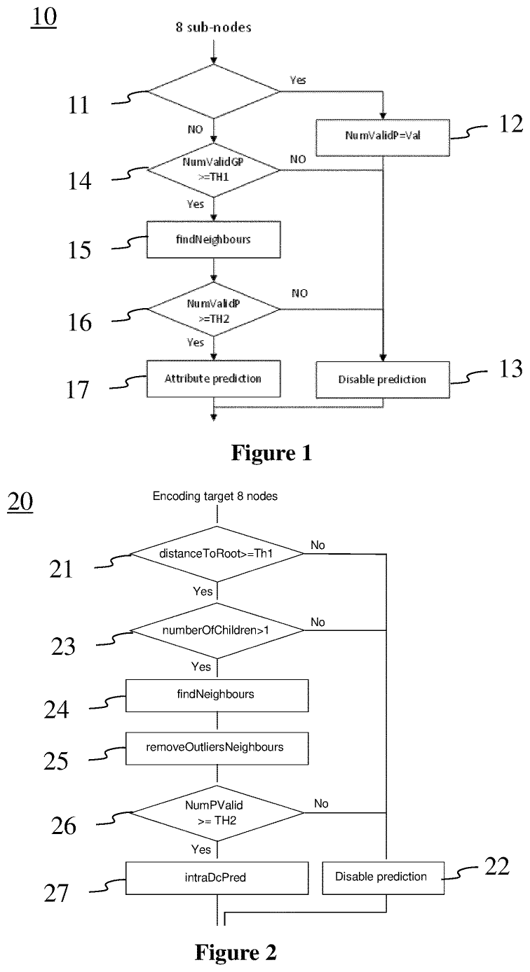

FIG. 1 illustrates an early termination decision workflow 10 to disable the transform domain prediction. A node is said valid when it contains at least one point. This information is provided by the occupation octree. At a step 11, the number of valid siblings is computed. If the considered node is the lonely child of its parent, then, at a step 12, and then the prediction is disabled in a step 13. At step 12, a number of parents is recorded in the memory associating the considered node with this number. Indeed, in such a case, this node inherits of the attributes of its parent without any modification. In case the considered node has siblings, then, at a step 14, the number of valid “great-parents” (that are the valid parents of the parent of the considered node used to predict the attribute values of the parent). According to the existing method, when this number is lower than a first threshold TH1 (for instance TH1=2 or 3 or 9), then the prediction is disable at step 13. Otherwise, at steps 15 and 16, the number of valid neighbours of the considered node is calculated. A neighbour is the parent or a valid uncle (that is a valid sibling of the parent of the considered node). When the number of valid neighbours is lower than a second threshold TH2 (for instance TH2=4 or 6 or 9), then the prediction is disabled at step 13. Otherwise, the prediction is performed at a step 17. In both cases, as in step 12, a number of parents is recorded in the memory associating the considered node with this number.

The early termination decision flow depicted in FIG. 1 depends on the number of grandparent nodes to decide for the early termination (NumValidGP≥Th1). As a single child node (i.e. a node without sibling, that is when the parent of the node has only one child) can still be used for prediction in the next level, the computation of the number of grandfather nodes that might be used for the next level is required. However, such a method may enable a prediction when the number of grandparents nodes suggest that the prediction is not useful.

FIG. 2 illustrates an early termination decision workflow 20 to disable the transform domain prediction according to the present principles. In this embodiment, the early termination workflow to disable the transform domain prediction is decorrelated from the number of grandparents nodes. The distance to the tree root (i.e. the level of the node) is used as a parameter to predict when it is necessary to execute the intra frame prediction and, outlier nodes are removed before computing the prediction. According to the present method, at a step 21, the level of the root is considered. If this level is lower than a threshold TH1 then, the prediction is disabled at a step 22. Indeed, if the level is low, its resolution is also low (the voxel is big and gathers a lot of points), so the prediction of the attribute values of its children does not bring precise new information. The present principles eliminate the dependency on the number of grandparents nodes for disabling the transform domain prediction as depicted in FIG. 1. Indeed, the number of (neighbouring) grandparent nodes increases as the considered node is further away from the tree root. According to the present principles, the distance to the tree root is used instead of the number of (neighbouring) grandparent nodes to decide when it is useful to predict the attributes of a node. This method allows to reduce the memory usage as there is no need to buffer the number of grandparents node. The dynamic memory byte consumption is reduced by a factor. For example, if integers are represented with four bytes, the memory reduction factor is eight (one integer for the parents and another integer for the great-parents).

If the level of the considered node is greater than a threshold TH1, then step 23 is performed. Step 23 is equivalent to step 11 of FIG. 1. If the number of children of the considered node equals one, then, no prediction is needed and step 22 is performed, that is the attribute prediction process is discarded. Otherwise, step 24 equivalent to step 15 is performed to find neighbours of the considered node. Then, at step 25, the outlier neighbours are removed. Indeed, some neighbour nodes may be ignored during prediction if their attributes (color, luminance, reflectance, normal vector, etc) are above or below a limit determined by the attribute values of the parent node of the considered node. For example, if the attribute value of a neighbour node is above 250% (or 200% or 300%) or below 20% (or 15% or 35%) of the attribute value of the parent node of the considered node, then, the neighbour node is considered as an outlier node and is removed from the list of neighbour nodes. At a step 26 equivalent to step 16 of FIG. 1, the number of valid neighbour nodes is calculated and, if it is greater than a given threshold TH2, the prediction is discarded at step 22. Otherwise, the intra prediction of the attributes of the considered node is performed at step 27.

The present principles apply to decoding process and to encoding process. Indeed, the method for keeping or discarding the prediction of the attribute values of a considered node has a direct effect on the encoding of the attribute value or on a residual value of the prediction. Encoded values are different because of the early termination decision workflow to disable the transform domain prediction according to the present principles.

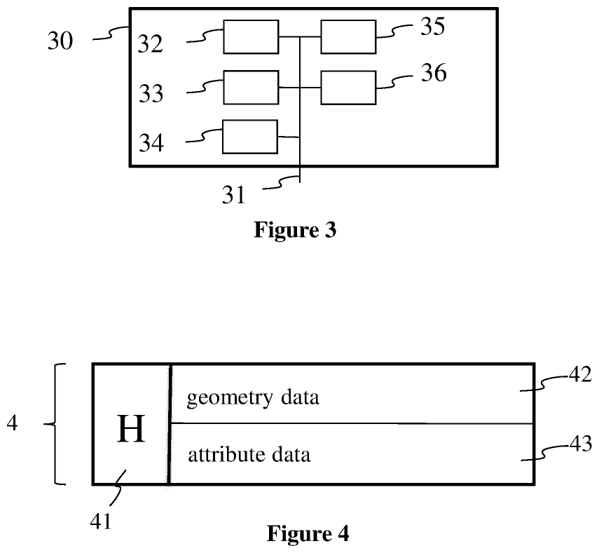

FIG. 3 shows an example architecture of a device 30 which may be configured to implement a method for encoding or decoding a point cloud according to the present principles. An encoder and/or a decoder may implement the method described in relation to FIG. 2. Alternatively, each circuit of the encoder and/or the decoder may be a device according to the architecture of FIG. 3, linked together, for instance, via their bus 31 and/or via I/O interface 36. Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 belongs to a set comprising:
a mobile device;
a communication device;
a game device;
a tablet (or tablet computer);
a laptop;
a still picture camera;
a video camera;
an encoding chip;
a server (e.g. a broadcast server, a video-on-demand server or a web server).

FIG. 4 shows an example of an embodiment of the syntax of a stream when the data are transmitted over a packet-based transmission protocol. FIG. 4 shows an example structure 4 of a stream encoding a point cloud according to the present principle. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure comprises a payload comprising an element of syntax 42 and at least one element of syntax 43 (there may be an element of syntax 43 for each type of attribute data, for instance one for the color, one for the reflectance, one for the normal vectors, etc.). Syntax element 42 comprises data representative of the geometry of the point cloud, that is a series of bits representative of the octree. Element of syntax 43 is a part of the payload of the data stream and may comprise data encoding the attribute values as represented in the point cloud or as residual data for a prediction step.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising:
obtaining a node tree linking nodes representative of a point cloud; and
for a considered node of the node tree, predicting an attribute value for the considered node if a level of the considered node in the node tree is lower than a first threshold and if a number of siblings of the considered node is greater than zero and if the number of valid neighbor nodes of the considered node is lower than a second threshold.

2. The method of claim 1, wherein a neighbor node is valid if a difference between a value of an attribute of the neighbor node and a value of a same attribute of a parent of the considered node is lower than a first percentage or greater than a second percentage.

3. The method of claim 1, wherein the node tree is an octree.

4. The method of claim 1, wherein a sibling of a node is another node having a same parent than the node and a neighbour is the parent of the node or a valid sibling of the parent of the node.

5. A device comprising a memory associated with a processor configured for:
obtaining a node tree linking nodes representative of a point cloud; and
for a considered node of the node tree, predicting an attribute value for the considered node if a level of the considered node in the node tree is lower than a first threshold and if a number of siblings of the considered node is greater than zero and if the number of valid neighbor nodes of the considered node is lower than a second threshold.

6. The device of claim 5, wherein a neighbor node is valid if a difference between a value of an attribute of the neighbor node and a value of a same attribute of a parent of the considered node is lower than a first percentage or greater than a second percentage.

7. The device of claim 5, wherein the node tree is an octree.

8. The device of claim 5, wherein a sibling of a node is another node having a same parent than the node and a neighbour is the parent of the node or a valid sibling of the parent of the node.

9. The device of claim 5, wherein, when the number of siblings of the considered node is greater than zero, outlier neighbour nodes are removed from the node tree.

10. The device of claim 6, wherein the node tree is an octree.

11. The device of claim 6, wherein a sibling of a node is another node having a same parent than the node and a neighbour is the parent of the node or a valid sibling of the parent of the node.

12. The device of claim 7, wherein a sibling of a node is another node having a same parent than the node and a neighbour is the parent of the node or a valid sibling of the parent of the node.

13. The method of claim 1, wherein, when the number of siblings of the considered node is greater than zero, outlier neighbour nodes are removed from the node tree.

14. The method of claim 2, wherein the node tree is an octree.

15. The method of claim 2, wherein a sibling of a node is another node having a same parent than the node and a neighbour is the parent of the node or a valid sibling of the parent of the node.

16. The method of claim 3, wherein a sibling of a node is another node having a same parent than the node and a neighbour is the parent of the node or a valid sibling of the parent of the node.
